(19) United States
(12) Patent Application Publication
(10) Pub. No.: US 2015/0251371 A1
(43) Pub. Date: Sep. 10, 2015

(54) METHOD OF SEALING COOLING HOLES

(71) Applicant: ROLLS-ROYCE PLC, London (GB)

(72) Inventors: Michiel KOPMELS, Bristol (GB); Simon CROWTHER, Goring (GB)

(73) Assignee: ROLLS-ROYCE PLC, London (GB)

(21) Appl. No.: 14/703,070

(22) Filed: May 4, 2015

Related U.S. Application Data
(62) Division of application No. 13/740,483, filed on Jan. 14, 2013.

(30) Foreign Application Priority Data
Jan. 19, 2012 (GB) 1200845.4

(51) Int. Cl. B29D 99/00; B29C 65/82

(52) U.S. Cl. CPC B29D 99/0053; B29C 65/8246; B29K 2101/12

(57) ABSTRACT

A method of sealing a gap between an aerofoil component and a further component. The method comprises placing the aerofoil component in close proximity with the further component to define a gap therebetween, applying a thermoplastic material to the gap in a molten phase and cooling the thermoplastic material to set the thermoplastic material.

This application is a divisional application of U.S. patent application Ser. No. 13/740,483 filed on Jan. 14, 2013, which claims priority to GB 1200845.4 filed on Jan. 19, 2012. The prior applications are incorporated herein by reference in their entirety.

### BACKGROUND OF THE INVENTION

The present invention relates to a method of sealing a gap between an aerofoil component and a further component. In particular, the invention relates to sealing a gap between a nozzle guide vane (NGV) and a fixture used for flow checking purposes.

Hollow aerofoil components such as turbine blades and NGVs provided in gas turbine engines often comprise internal passages, which extend from the hollow interior of the blade to the exterior to provide a cooling air film in use, and thereby cool the surface of the component.

It is sometimes necessary to test the performance of such passages, for example to validate a new component design, or to diagnose blockages during engine overhaul or repair. A previous method of testing NGVs comprises placing the NGV to be tested in a tight fitting rubber or silicone housing, and clamping the housing against the NGV. However, such a method requires a relatively close fit between the housing and the NGV to be tested. Gas turbine engines typically comprise a large number of NGVs having slightly different dimensions, and so a large number of housings must be provided to test each NGV.

The present invention provides an improved method of sealing an aerofoil component against a further component that addresses some or all of the aforementioned problems.

### SUMMARY OF THE INVENTION

According to the present invention there is provided a method of sealing a gap between an aerofoil component and a further component, the method comprising:
placing the aerofoil component in close proximity with the further component
to define a gap therebetween;
applying a thermoplastic material in a molten phase to the gap; and
cooling the thermoplastic material to set the thermoplastic material.

It has been found that by applying a thermoplastic material to the gap between an aerofoil component and a further component, a relatively large gap can be effectively sealed. As a result, a less precise alignment between the aerofoil and the component can be provided, which can still be sealed. This in turn has the effect that a single housing can be used for differently shaped NGVs. It has also been found that this method is capable of forming a robust seal, which cures in a relatively short time and can be melted and reformed to permit repair of a defective seal. It has been found that the seal is typically effective up to a pressure ratio of 2:1, which is the pressure typically required for NGV testing.

The method may comprise heating at least one of a surface of the aerofoil component and the further component to a temperature above 20° C. while the thermoplastic material is applied to facilitate adhesion. The surface of the aerofoil component may be heated to between 50° C. and 60° C. The heated surface may be heated by an air gun, and the air provided by the air gun may have a temperature of between 140° C. and 170° C.

By heating the surface of the aerofoil component or the further component prior to applying the thermoplastic material, the time taken for the thermoplastic to solidify is increased. As a result, the thermoplastic material remains in its molten state for a longer duration, and so provides a larger wetted surface in contact with the surface of the aerofoil component and the further component, thereby leading to improved sealing between the two components.

The thermoplastic material may comprise Ethylene-vinyl acetate (EVA). The thermoplastic material may comprise Tec-Bond 240™, or may comprise Tec-Bond 260™.

### BRIEF DESCRIPTION OF THE DRAWINGS

The present invention will be more fully described by way of example with reference to the accompanying drawings, in which:

FIG. 1A is a plan view of an aerofoil and a further component sealed using a first method in accordance with the present invention;

FIG. 1B is a side view along the line A-A of the method of FIG. 1A;

FIG. 2 is a side view of a second method in accordance with the present invention;

FIG. 3A is a side view of an adhesive bead following solidification where the preheating step is employed; and

FIG. 3B is a side view of an adhesive bead following solidification where the preheating step is not employed; and

FIG. 4 is a perspective view of an aerofoil component.

### DETAILED DESCRIPTION OF THE PREFERRED EMBODIMENTS

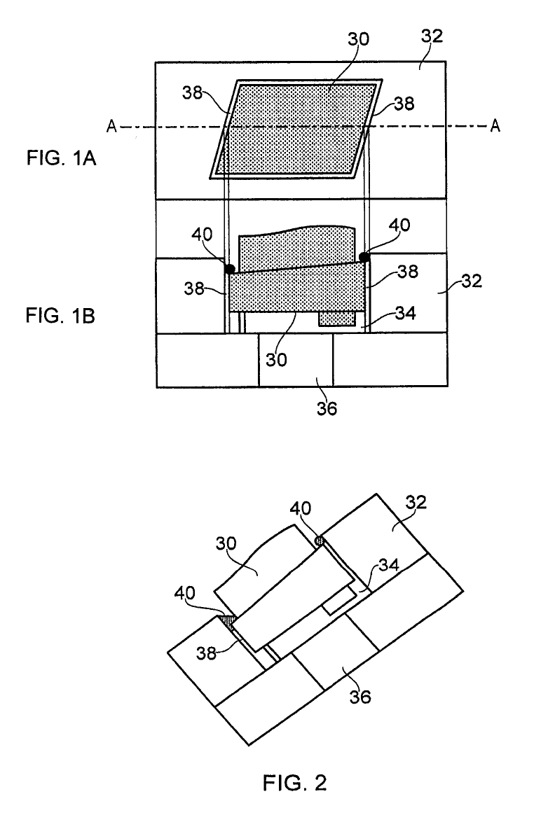

FIGS. 1A and 1B show a first method of sealing an aerofoil component such as a nozzle guide vane (NGV) 30 for a gas turbine engine (not shown), to a further component in the form of a housing 32. The NGV is shown in detail in FIG. 4. The NGV 30 comprises Nickel Alloy, with a surface coating of ceramic thermal barrier material. The NGV may alternatively be uncoated. The housing 32 is formed of a plastics material, and includes a cavity 34, shaped to correspond to an external profile of the NGV 30, and an aperture 36 for introducing compressed air to the cavity 34. In use, the NGV 30 is placed in the cavity 34 for testing.

The shape of the cavity 34 does not necessarily precisely correspond to the profile of the NGV 30, such that a gap 38 is generally defined between the edges of the cavity 34 and NGV 30. The gap 38 is generally 0.25 to 0.5 mm wide when the NGV 30 is placed in the cavity 34. Such a gap 38 enables slightly different shaped NGVs to be tested in the same housing 32.

The gap 38 between the NGV 30 and the housing 32 is sealed using the following method. One or both of the NGV 30 and the housing 32 is heated to a temperature above 20° C., and preferably to a temperature of around 50° C. to 60° C. The heating step could be carried out using any suitable process. For example, hot air could be applied to the NGV 30 using an air gun. Where an air gun is used, the hot air supplied by the air gun is supplied at a temperature of between 140° C. and 170° C. This has been found to be sufficient to provide a surface temperature of 50° C. to 60° C. Alternatively, the whole assembly (i.e. both the NGV 30 and the housing 32) could be placed in an oven (not shown) during the heating step. In a still further alternative, an electrical current could be conducted or induced in the NGV 30 to provide resistive or inductive heating.

Subsequent to the heating step, a bead 20a of thermoplastic material in the form of Tec-Bond 240™, or Tec-Bond 260™ thermoplastic hot melt adhesive in a molten phase (i.e. above the melting point of the material) is applied to the gap 38. The particular type of adhesive used will depend on a number of factors, including the required strength of the bond, and the properties of the NGV. Where the NGV comprises Nickel alloy having a ceramic thermal barrier coating, Tec-Bond 240™, or Tec-Bond 260™ have been found to be suitable. Applying the adhesive at a temperature of approximately 200° C. has been found to result in the adhesive having the correct viscosity to cover the gap 38 without an excessive amount running into the cavity 36. The adhesive bead 20a is then allowed to cool to a temperature of around 20° C. and set, i.e. solidify, to form a seal between the NGV 30 and housing 32 across the gap 38. The cooling time may be controlled by, for instance, controlling the ambient temperature or air flow around the NGV 30 and housing 32.

Alternatively, the heating step could be omitted, and a bead 20b of thermoplastic material could be applied with both of the NGV 30 and housing 32 at ambient temperature, i.e. around 20° C., and allowed to cool.

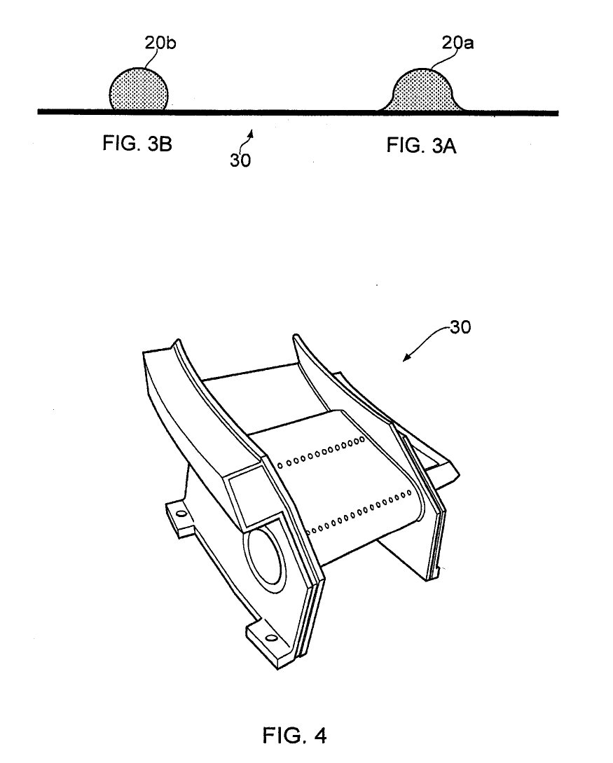

FIGS. 3A and 3B show the beads 20a, 20b applied with and without the heating step respectively. The heating step results in one or both of the NGV 30 and housing 32 being at a higher temperature (i.e. around 50° C. to 60° C.) when the adhesive bead 20a is applied, relative to when the heating step is omitted, where the NGV 30 and housing 32 would be at room temperature (i.e. around 20° C.). As a result of the heating step, the bead 20a cools more slowly and more evenly than when the heating step is omitted, resulting in the bead 20a remaining in the molten phase for a longer period in comparison to the bead 20b. As a result, the bead can spread further into the gap 38 before solidifying, thereby resulting in a larger surface area of the bead 20a in contact with the edges of the NGV 30 and housing 32, thereby forming an improved seal. However, such a heating step increases the time taken to seal the gap 38 due to both the time taken to heat the NGV 30 and or housing 32, and the longer cooling time required for the adhesive to set. Generally, the NGV 30 requires heating to ensure good adhesion, though it has been found that where the housing 32 comprises a plastics material, heating of the housing 32 is not necessary to provide good adhesion.

In contrast, where the heating step is omitted, part of the bead 20b in contact with the edges of the NGV 30 and housing 32 cools very quickly when applied. As a result, the part of the bead 20b in contact with the edges of the NGV 30 and housing 32 solidifies very quickly and contracts, resulting in a more spherical, less flattened shape relative to bead 20a, and thus a lower area in contact with the surface 22. The rounded shape of the bead 20b is also easier to peel off relative to the flattened shape of the bead 20a.

FIG. 2 shows a second method of sealing an aerofoil component such as a nozzle guide vane (NGV) 30, to a housing 32. The NGV 30 and housing 32 are the same as used in the method described in relation to FIGS. 1A and 1B, but the adhesive is applied with the base of the housing 32 at an angle to the horizontal, such that the adhesive runs into the gap 38 on the lower side of the housing 32. This method has been found to provide an improved seal relative to when the adhesive is applied with the base parallel to the horizontal, since a thicker bead 40 can be provided.

Once the adhesive bead 20 has solidified, the NGV 30 can be tested by passing compressed air into the housing 32 through the aperture 36. If the seal is found to be defective however, i.e. some air is able to pass through the gap 38 during testing, the seal can be repaired. This can be done either by adding further material as above, or by applying localised heat (for example using a soldering iron or glue gun tip) to the defective bead 20, such that it is heated above its melting point. The melted bead 20 is then allowed to flow across the gap 38 to thereby cover the defect. The repaired bead 20 is then allowed to cool, and the NGV 30 can be tested again. The present invention therefore permits the seal to be repaired, without removing or necessarily adding further material to the blade. This method thereby saves time in comparison to prior sealing methods, in which the sealant has to be removed and reapplied where a defective seal is found.

Once testing is complete, the adhesive bead 20 can be removed by hand, by peeling the solidified adhesive from the gap 38. The NGV 30 may be heated to soften or partially melt the adhesive to facilitate removal. Once removed, very little residue remains. The residue has been found not to gas turbine engine components, and is generally burned off during operation of the gas turbine engine.

While the invention has been described in conjunction with the examples described above, many equivalent modifications and variations will be apparent to those skilled in the art when given this disclosure. Accordingly, the examples of the invention set forth above are considered to be illustrative and not limiting, Various changes to the described embodiment may be made without departing from the spirit and scope of the invention.

For example, where the NGV includes film cooling holes, the thermoplastic material could be applied to one or more of the cooling holes to seal these for testing. Different thermoplastics could be used for sealing the holes, depending on the required adhesion properties. In particular, this will be dependent on the pressures used during testing, as higher pressures will require a stronger adhesion. The method could also be used to join other components such as turbine blades. The component for testing and the housing could be made from substantially any materials, and different adhesives and preheating steps may be required for different materials. However the invention has been found to work particularly well for Nickel alloy components and plastics material housings.

1. A method of testing a nozzle guide vane of a gas turbine engine having a plurality of cooling holes, the method comprising:
placing the nozzle guide vane within a cavity of a component housing to define a gap therebetween;
applying a thermoplastic material to the gap in a molten phase;
cooling the thermoplastic material to set the thermoplastic material; and
introducing compressed air to the cavity.

2. A method according to claim 1, further comprising heating at least one of a surface of the nozzle guide vane and the component housing, such that the heated surface is at an above ambient temperature while the thermoplastic material is applied to facilitate adhesion.

3. A method according to claim 2, wherein the heated surface is heated to between 50° C. and 60° C.

4. A method according claim 1, further comprising applying the thermoplastic material to one or more selected cooling holes of the plurality of cooling holes in a molten phase and allowing the thermoplastic material to cool, wherein the thermoplastic material is applied with a base of the component housing at an angle to the horizontal.
